(19) United States
(12) Patent Application Publication
(10) Pub. No.: US 2007/0050544 A1
(43) Pub. Date: Mar. 1, 2007

(54) System and method for storage rebuild management

(75) Inventors: Rohit Chawla, Austin, TX (US); Ahmad Hassan Tawil, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/217,563

(22) Filed: Sep. 1, 2005

(51) Int. Cl. G06F 12/16

(52) U.S. Cl. 711/114

(57) ABSTRACT

An information handling system includes a first and second storage volumes each having a plurality of storage resources and a management module. An upper layer management module acts to manage the mirroring of the first and second storage volumes and to receive detected storage resource failure notifications from the management modules. The upper level management module then initiates a rebuild of the failed storage resource, without requiring a rebuild of an entire storage volume.

### TECHNICAL FIELD

The present invention is related to the field of computer systems and more specifically to a system and method for managing rebuild and partial rebuild operations of a storage system.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use storage systems such as Redundant Array of Independent Disks (RAIDs) for storing information. RAIDs typically utilize multiple disks to perform input and output operations and can be structured to provide redundancy which can increase fault tolerance. In operation, a RAID appears to an operating system as a single logical unit. RAID often employs a technique of striping which involves partitioning each drive storage space in the units ranging from a sector up to several megabytes. The disks which make up the array are then interleaved and addressed in order. There are multiple types of RAIDs including RAID-0, RAID-1, RAID-2, RAID-3, RAID-4, RAID-5, RAID-6, RAID-7, RAID-10, RAID-50 and RAID-53.

A RAID 0 volume consists of member elements such that the data is uniformly striped across the member disk but does not include any redundancy of data. In RAID 1 volume information stored within the first member disk is mirrored to the second member disk. In RAID-1 system a technique of mirroring is typically used such that the information stored within a first RAID volume is also stored in a mirrored manner on a second RAID volume. RAID-0 also utilizes striping but does not include redundancy of data. The independent volumes can be striped to create secondary striped RAID volumes such as RAID 10. In such RAID volume data is mirrored between member disks such that each member disk is a RAID 0 volume.

However, a number of problems exist related to the failure of one or more physical disks within a RAID array. For instance, in a RAID-10 system which includes two volumes with the second volume mirroring the first volume if a single disk within the first volume fails the entire first volume will need to be rebuilt. This will require that not only the disk which has failed will be rebuilt using the data stored on the second, mirrored volume but that all of the disks within the first volume are copied from the second mirrored volume. This method of addressing failures has a number of drawbacks. One drawback is that the rebuild time for rebuilding the volume after a disk failure is lengthy. Additionally, after the failure of a disk within the first volume is detected, the other disks within the array are often unavailable to satisfy input and output requests from a user and the second, mirrored volume is utilized to satisfy all I/O requests.

In other RAID systems that utilize parity information for rebuilding a single disk after a failure is detected, in the event of the simultaneous failure of more than one disk, similar problems exist for conducting rebuild operations in the RAID systems.

### SUMMARY OF THE INVENTION

Therefore a need has arisen for an improved system and method for managing the failure of individual storage resources in a RAID system.

A further need has arisen for a system and method for conducting a partial rebuild of a RAID system.

In one aspect an information handling system is disclosed that includes the first storage volume having a first plurality of storage resources and a first management module. The first management module monitors the plurality of storage resources. The system also includes a second storage volume that has a second plurality of storage resources and a second management module. The second management module acts to monitor each of the second plurality of storage resources. The first storage volume and a second storage volume comprise a common storage layer in the second storage volume that mirrors at least part of the first storage volume. The first storage volume and the second storage volume are connected to an upper storage layer that includes an upper layer management module. The first management module and the second management module may notify the upper layer management module of a detected storage resource failure. The upper level management module may then act to rebuild the failed storage resource.

In another aspect, an upper layer storage resource is disclosed that includes an upper layer management module. The upper layer management module is able to receive detected storage resource failure data from a first management module associated with the plurality of storage resources. The resource failure data indicates at least one failed storage resource. The upper layer management module is also able to retrieve a copy of the data that was stored on the failed storage resource from a second management module associated with a second plurality of storage resources. The second plurality of storage resources mirrors the first plurality of storage resources. Additionally, the upper layer management module is able to rebuild the failed storage resource using data copied from the second plurality of storage resources.

In yet another aspect, a method is described that includes receiving, at an upper layer management module, detected storage resource failure data from a first management module associated with a first plurality of storage resources. The resource failure data indicates at least one failed storage resource. The method also includes retrieving a copy of the data stored on the failed storage resource from a second management module associated with a second plurality of storage resources. The second plurality of storage resources mirrors the first plurality of storage resources. The method also includes rebuilding the failed storage resource using data copied from the second plurality of storage resources.

The present disclosure includes a number of important technical advantages. One important technical advantage is providing an upper level management module. This allows for an improved system and method for managing failure of storage resources at a lower layer and also facilitates the partial rebuilding of individual storage resources or physical disks within a lower layer of a RAID system.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a diagram of a multiple layer storage system according to the teachings of the present disclosure;

FIG. 2 shows a diagram showing an example of data striping on mirrored storage volumes;

FIG. 3 shows a diagram of a storage system according to the teachings of the present disclosure;

FIG. 4 shows a network which may be used to implement teachings of the present disclosure;

FIG. 5 shows a single system incorporating teachings of the present disclosure;

FIG. 6 is a flow diagram showing a method for redirecting input and output requests according to teachings of the present disclosure; and

FIG. 7 shows a flow diagram showing a method for partially rebuilding a failed storage resource according to teachings of the present disclosure.

### DETAILED DESCRIPTION OF THE INVENTION

Preferred embodiments of the invention and its advantages are best understood by reference to FIGS. 1-7 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system indicated generally at 10 is shown. Information handling system 10 includes upper storage layer 12 which is in communication with first storage volume 14 and second storage volume 16. Upper storage layer 12 is at a layer referred to as “R1” in the present embodiment and may also be referred to as the “mirroring layer”. First storage volume 14 and second storage volume 16 are both at a layer “R0” in the present embodiment which may also be referred to herein as a secondary layer. Upper storage layer 12 also includes upper layer management module 26. First storage volume 14 includes first management module 28; second storage volume 16 includes second management module 30.

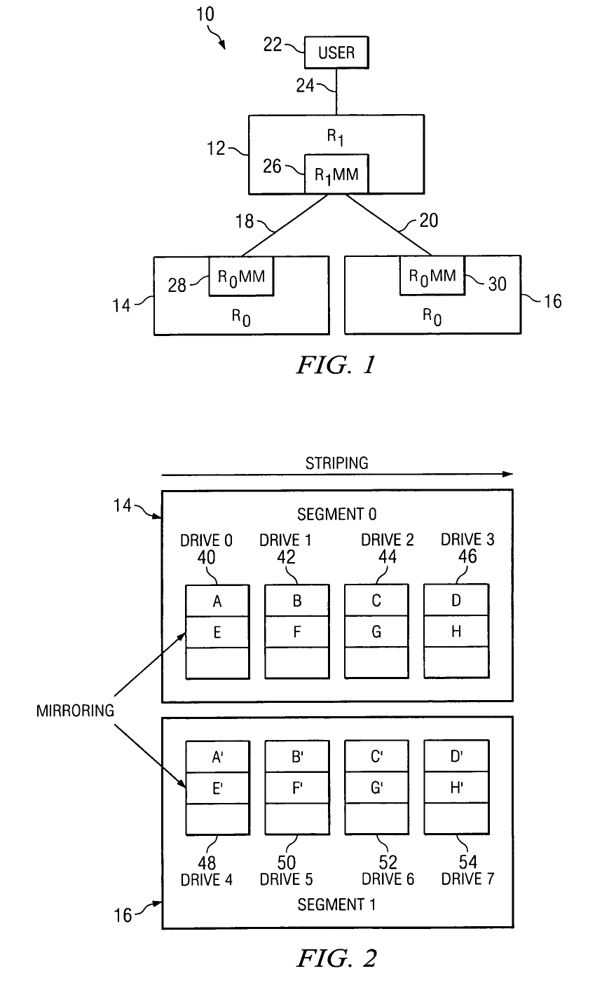

User or client node 22 is connected with upper storage layer 12 via connection 24. User node 22 sends input/output (I/O) requests to upper storage layer 12. Upper storage layer 12 then processes the I/O requests from client node 22 and retrieves the requested data from either first storage volume 14 or second storage volume 16. In the event that client node 22 requests that new data is stored, upper storage layer 12 manages the storage of files onto storage volumes 14 and 16. First storage volume 14 preferably includes a plurality of storage resources (as shown in FIGS. 2 & 3) such as a plurality of physical disks, hard drives or other suitable storage resources. Second storage volume 16 also includes a plurality of physical disks or hard drives or other suitable storage resources. In the present preferred embodiment the information stored within first storage volume 14 is mirrored by second storage volume 16. In alternate embodiments first or second storage volumes 14 or 16 may contain only a partial copy or partial mirroring of the other storage volume.

Upper layer management module 26 may also be described as an R1 management module (RIMM) or as a RAID-1 management module. Upper layer management module 26 is preferably operable to receive failure notifications from the management modules 28 and 30 associated with first and second storage volumes 14 and 16. In a preferred embodiment, such failure notifications may include a bit-map indicating storage locations effected by the detected failure. Additionally, the upper layer management module may deem the storage volume effected by the detected failure to be “partially optimal” until the detected failure is corrected.

Upper layer management module 26 may then initiate a partial rebuild operation to repair detected storage resource failures contained within the first or second storage volume. Upper layer management module 26 and management modules 28 and 30 represent any suitable hardware or software including controlling logic for carrying out functions described. Before the partial rebuild is complete, upper layer management module 26 may receive I/O requests from user 22. As described below, upper layer management module 26 may manage the I/O requests differently when a storage volume is partially optimal than when both storage volumes are optimal.

Upper layer management module 26, first management module 28, and second management module 30 each preferably incorporate one or more Application Program Interfaces (APIs). Each API may perform a desired function or role for interfacing between layer R1-12 and layer R0-14 & 16. For example, first management module 28 and second management module 30 may each contain an API that acts to monitor the individual storage resources contained within each storage volume.

Once a storage resource is detected to no longer be functioning, to be malfunctioning, or a failure has otherwise been detected, the respective API then sends an appropriate notification to upper layer management module 26. Other APIs may act to transmit configuration information related to the respective storage volume. This configuration information may be information related to the type of RAID under which the storage volume is operating, to striping size and to information identifying the various elements of each RAID volume. Management modules 28 and 30 may also report when one of the plurality of storage resources has been removed such as during a so-called “hot swap” operation. The upper layer management module 26 may include an API such as a discovery API which acts to determine or request the configuration of the storage volumes 14 and 16, determine the identification for the various RAID elements and also configuration data.

As discussed in greater detail below, connections 18 and 20 may be either a network connection such as a Fibre Channel (FC), Small Computer System Interface (SCSI), a SAS connection, iSCSI, Infiniband or may be an internal connection such as a PCI or PCIE connection.

Now referring to FIG. 2, showing storage volumes 14 and 16 and the striping of information thereon. FIG. 2 shows first storage volume 14 including zero drive 40, first drive 42, second drive 44 and third drive 46. In the present embodiment, storage volume 14 is referred to as segment 0. Second storage volume 16 is referred to generally as segment 1 and includes fourth drive 48, fifth drive 50, sixth drive 52 and seventh drive 54. Data stored on each storage volume 14 and 16 is striped, as shown, such that defined blocks or stripes of data is consecutively stored in each volume of storage resources (40, 42, 44 & 46 or 48, 50, 52 & 54). As shown, first storage volume 14 is mirrored by second storage volume 16 in that the striping that is stored within the drives of storage volume 14 are mirrored by the drives of storage volume 16. For instance, strips A and E are stored in zero drive 40 of first storage volume 14 and strips A and E are mirrored in fourth drive 48 of storage volume 16.

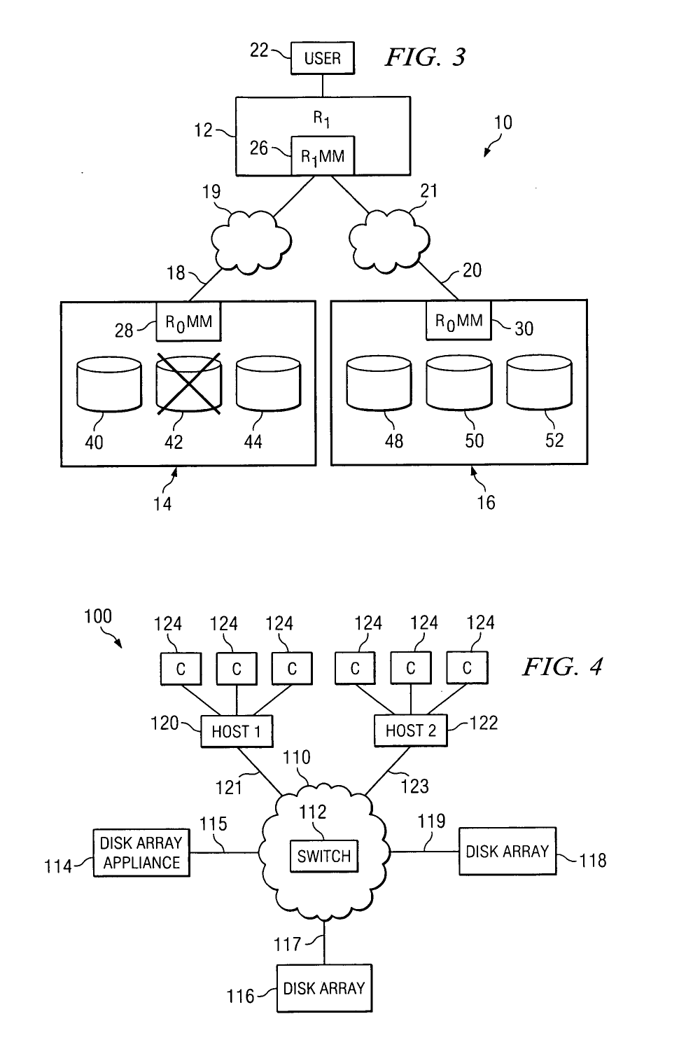

Now referring to FIG. 3, a layered RAID storage system 10 according to the teachings of the present disclosure is shown. System 10 includes upper storage layer 12 in communication with first storage volume 14 and second storage volume 16. As shown, first storage volume 14 includes storage resources 40, 42 and 44; second storage volume 16 includes storage resources 48, 50 and 52.

As shown in the present embodiment, a failure has occurred within storage resource 42. In operation, first management module preferably detects that a failure has occurred within storage resource 42. This may be accomplished, for example, by first management module 28 periodically checking the status of each associated storage resource, by not receiving a response to a communication, by receiving an alert or an alarm message from the storage resource or by another suitable method for detecting a failure. First management module 28 then communicates this information to upper layer management module 20 via connection 18.

In the present embodiment connection 20 comprises a connection via network 19. Upper layer management module 20 then preferably determines that the information contained on failed storage resource 42 is mirrored on the corresponding storage resource 50 of second storage volume 16.

Upper layer management module 20 then preferably initiates a rebuild operation whereupon information stored on storage resource 50 is copied by upper layer management module 20 onto a replacement storage resource installed in place of existing storage resource 42. Alternatively, upper layer management module 20 may direct that the requested data be copied onto storage resource 42 after it is repaired or after an error condition has been corrected.

Prior to the completion of this partial rebuild of first storage volume 14, user 22 may be initiating I/O requests for data stored on storage volumes 14 and 16. During this time upper layer management module 20 preferably directs requests for data stored on a failed storage resource (such as failed storage resource 42 of the present embodiment) (such as storage volume 50 of second storage volume 16) where the request may be fulfilled. However, requests for data contained in the storage resources of first storage volume 14 that are otherwise available (in the present embodiment, data available in storage resources 40 and 44) may be directed to first volume 14. Upper management module 20 may also perform load balancing based on the traffic of I/O requests such that the overall number of requests or amount of data being requested from first and second storage volumes 14 and 16 are substantially balanced or equalized.

Now referring to FIG. 4, an information handling system, indicated generally at 100 is shown. Information handling system 100 includes Disk arrays (or volumes) 116 and 118, disk array appliance 114, and hosts 120 and 122 in communication with network 110. Disk arrays 116 and 118 are in communication with network 110 via connections 117 and 119, respectively. Network 100 includes switching element 112 which is preferably able to manage the switching of traffic between disk arrays 116 and 118 and with disk array appliance 114 and hosts 120 and 122. Host 120 is connected with network 110 via connection 121.

Host 122 is in communication with network 110 via connection 123. Disk array/appliance 114 is in communication with network 110 via connection 115. Connections 115, 117, 119, 121 and 123 may comprise any suitable network connections for connecting their respective elements with network 110. Connections 115, 117, 119, 121 and 123 may be FC SCSI, SAS, iSCSI, Infiniband or any other suitable network connections. First host 120 is in communication with clients 124. Host 122 is similarly in communication with multiple clients 124.

In the present embodiment disk arrays 116 and 118 may mirror one another similar to the storage volumes 14 and 16 described with respect to FIGS. 1-3. Disk arrays 116 and 118 may include management modules 28 and 30. The upper layer management module may be provided in a variety of different components/locations. For example, upper layer management module which manages disk arrays 116 and 118 according to the present disclosure may be provided within disk array/appliance 114 or may be provided within switching element 112. Alternately, the upper level management module may be provided in either host element 120 or 122. In such embodiments, the upper layer management module will be connected with the lower layer management modules via a network connection as shown. In alternate embodiments, upper level management module.

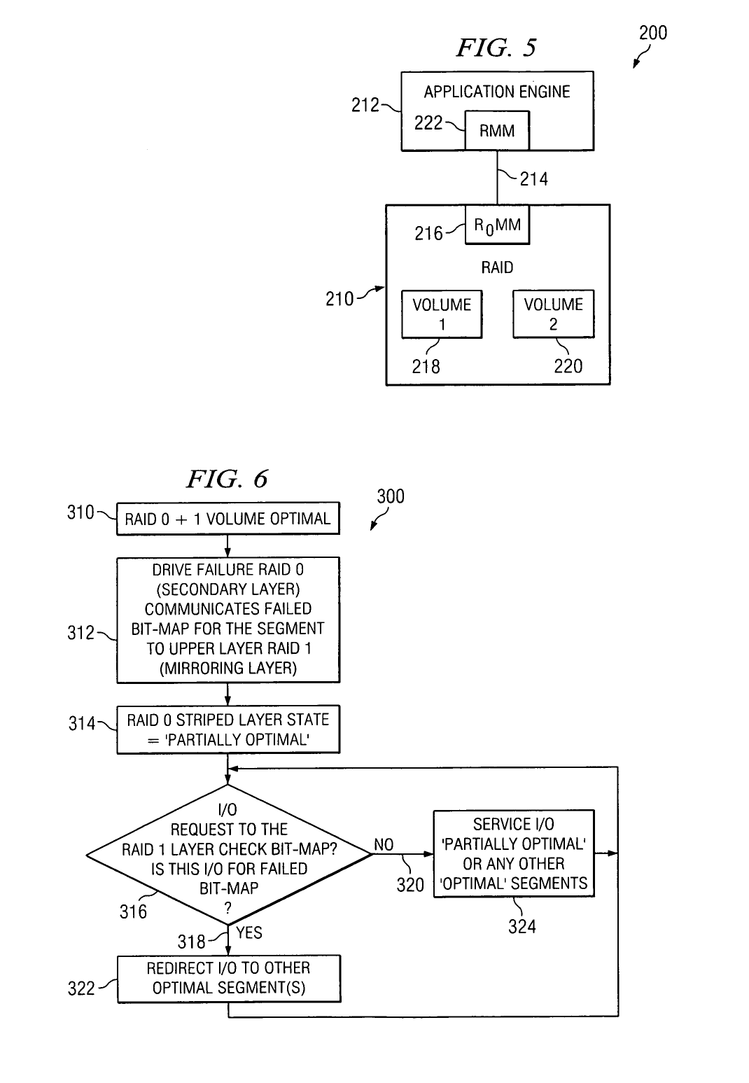

Now referring to FIG. 5, a information handling system 200 is shown. Information handling system 200 includes an application engine 212 in communication with a RAID 210. RAID 210 includes a first volume 218 and a second volume 220. The first volume 218 includes plurality of storage resources. Second volume 220 also includes a plurality of storage resources mirroring the information stored within first volume 218. RAID 210 includes management module 216. RAID 210 is in communication with application engine 212 via connection 214. Application engine 212 includes an upper layer management module 222. Connection 214 may preferably be an internal system connection such as a bus utility PCIE or another suitable communication protocol.

Now referring to FIG. 6, a flow diagram, indicated generally at 300 of a method according to the present disclosure is shown. At the method begins, a multiple layer RAID system (RAID0+1) is operating at an optimal capacity 310. Next, a drive failure occurs within a storage volume and the secondary layer (RAID Level 0) communicates a failed bit-map for a failed segment to the upper layer RAID 1 (which is also the layer that manages mirroring in the secondary layer) 312. The secondary layer is determined to be partially optimal by the upper layer of the RAID 314.

The upper layer (RAID 1) then receives input and output requests from an associated host, and upper layer RAID checks the bit map to determine whether the input/output relates to a failed portion of the secondary layer 316. In the event that the request is not affected by a secondary layer failure 320, the I/O request may be serviced by the partially optimal volume or by the fully optimal volume 324. However, in the event that the request requires part of the failed bit map 318, the request is directed to an optimal segment of the secondary layer 322 (e.g. the storage volume that does not have a failed disk). The method continues by then awaiting the receipt of additional requests or notifications of additional drive failures.

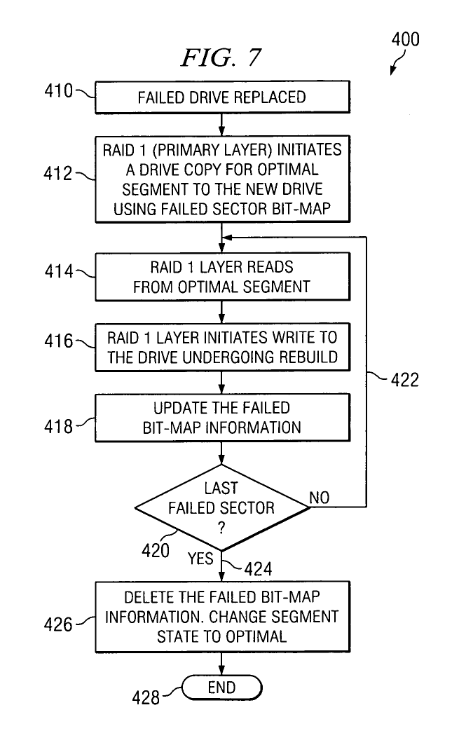

Now referring to FIG. 7, a flow diagram of a method indicated generally at 400 is shown. The method begins after a failed drive has been detected within the secondary layer of a RAID and the failed drive is replaced 410. At this time, the primary layer (RAID 1) initiates the copying of the appropriate drive onto the new drive 412. This copying may preferably utilizes the failed bit map that has been stored on the mirroring layer of RAID 1 as described with respect to FIG. 6. The mirroring layer reads the data that had been located on the failed sector bit nap from the optimal segment 414 and initiates a write to the drive undergoing rebuild 416.

The failed bit map information of RAID 1, is updated 418. Next, it is determined whether the last sector has been rebuilt 420. In the event that additional sectors are left to be rebuilt 422, the method proceeds to step 414. In the event that all the failed sectors have been rebuilt 424, the failed bit map information is deleted and the state of the secondary layer is changed to optimal 426, thereby ending the method 428.

Although the disclosed embodiments have been described in detail, it should be understood that various changes, substitutions and alterations can be made to the embodiments without departing from their spirit and scope.

What is claimed is:

1. An information handling system comprising:
a first storage volume having a first plurality of storage resources and a first management module, the first management module operable to monitor each of the first plurality of storage resources;
a second storage volume having a second plurality of storage resources and a second management module, the second management module operable to monitor each of the second plurality of storage resources;
the first storage volume and the second storage volume comprising a common storage layer and the second storage volume mirroring at least a portion of the first storage volume;
the first storage volume and the second storage volume coupled to an upper storage layer having an upper layer management module;
the first management module and the second management module operable to notify the upper layer management module of a detected storage resource failure; and
the upper layer management module operable to initiate a partial rebuild operation to repair the detected storage resource failure.

2. An information handling system according to claim 1 wherein the first storage volume and the second storage volume comprise a first RAID volume and a second RAID volume.

3. An information handling system according to claim 1 wherein the first RAID volume and the second RAID volume are formed in accordance with a standard selected from the group consisting of RAID 0, RAID 1 and RAID 5.

4. An information handling system according to claim 1 wherein the first plurality of storage resources and the second plurality of storage resources comprise a first plurality of physical disks and a second plurality of physical disks.

5. An information handling system according to claim 1 wherein the first storage volume and the second storage volume are coupled to the upper storage layer via a network connection.

6. An information handling system according to claim 1 wherein the first storage volume and the second storage volume are coupled to the upper storage layer via an internal connection.

7. An information handling system according to claim 1 wherein the upper storage layer is associated with a host.

8. An information handling system according to claim 1 wherein the upper storage layer is associated with a switch element.

9. An information handling system according to claim 1 wherein the upper storage layer is associated with a disk array.

10. An information handling system according to of claim 1 wherein the first storage volume and the second storage volume are housed in a common enclosure.

11. An information handling system according to claim 1 wherein the first storage volume and the second storage volume are housed in separate enclosures.

12. An information handling system according to claim 1 wherein the upper layer management module comprises at least one Application Program Interface (API).

13. An upper layer storage resource comprising:
an upper layer management module operable to:
receive detected storage resource failure data from a first management module associated with a first plurality of storage resources, the resource failure data indicating at least one failed storage resource;
retrieve a copy of the data stored on the failed storage resource from a second management module associated with a second plurality of storage resources, said second plurality of storage resources mirroring the first plurality of storage resources; and
rebuild the failed storage resource using the data copied from the second plurality of storage resources.

14. A storage resource according to claim 13 wherein the first management module and the second management module comprise a common storage layer.

15. A storage resource according to claim 13 wherein the upper layer management module further comprises at least one Application Program Interface (API).

16. A storage resource according to claim 13 wherein the upper layer management module is operable to receive input/output (I/O) requests from an associated client.

17. A storage resource according to claim 16 wherein the upper layer management is operable to periodically receive configuration data from the first management module and the second management module.

18. A method comprising:
receiving at an upper layer management module, detected storage resource failure data from a first management module associated with a first plurality of storage resources, the resource failure data indicating at least one failed storage resource;
retrieving a copy of the data stored on the failed storage resource from a second management module associated with a second plurality of storage resources, said second plurality of storage resources mirroring the first plurality of storage resources; and
rebuilding the failed storage resource using the data copied from the second plurality of storage resources.

19. A method according to claim 18 wherein receiving detected storage resource failure data comprises receiving bit map information related to the failed storage resource.

20. A method according to claim 19 further comprising updating the bit map information after rebuilding the failed storage resource.
